(19) United States
(12) Patent Application Publication
(10) Pub. No.: US 2025/0084282 A1
(43) Pub. Date: Mar. 13, 2025

(54) REINFORCED RELEASABLE ADHESIVE

(71) Applicant: Apple Inc., Cupertino, CA (US)

(72) Inventors: Erik G. DE JONG, San Francisco, CA (US); Antonio F. HERRERA, Woodside, CA (US); Daniela M. DESCHAMPS, Palo Alto, CA (US); Yi Lin CHEN, Mountain View, CA (US)

(21) Appl. No.: 18/637,346

(22) Filed: Apr. 16, 2024

Related U.S. Application Data
(60) Provisional application No. 63/538,252, filed on Sep. 13, 2023.

(51) Int. Cl. C09J 7/28; G04G 17/04; H01M 50/218; H01M 50/247

(52) U.S. Cl. CPC C09J 7/28; H01M 50/218; H01M 50/247; C09J 2203/326; C09J 2301/208; C09J 2301/502; C09J 2400/163; G04G 17/04; H01M 2220/30

(57) ABSTRACT

An apparatus is designed to secure a component (e.g., battery) to a housing of an electronic device and to remove the power supply from the electronic device with minimal or no breaking. The apparatus may include an adhesive layer and a reinforcement layer (e.g., wire) that extends throughout the adhesive layer. When a force is applied to the adhesive layer, the reinforcement layer allows the adhesive layer to stretch and lengthen without breaking. The apparatus may further include an extension where the applied force can be initiated, and the reinforcement layer may extend into the extension. The reinforcement layer may also be used to sever the adhesive layer. For example, an applied force to the reinforcement layer can cut the adhesive layer. Alternatively, thermal energy may be applied to the reinforcement layer, causing the reinforcement layer to change shape and separate the adhesive layer.

### CROSS REFERENCE TO RELATED APPLICATIONS

This application claims the benefit of U.S. Provisional Application No. 63/538,252, entitled “REINFORCED RELEASABLE ADHESIVE,” filed Sep. 13, 2023, the entirety of which is incorporated herein by reference.

### TECHNICAL FIELD

This application is directed to adhesives, and more particularly, to an adhesive with a layer of reinforced material embedded in the adhesive that allows that adhesive to stretch upon release from a device while also minimizing or preventing tearing of the adhesive.

### BACKGROUND

In some instances, removing a component (e.g., battery) from an electronic device during production, or in the field is necessary for repair. One solution is to use stretch release adhesives. However, stretch release adhesives are limited in strength, thus limiting the ability to pull the adhesive body at relatively high angles (e.g., relative to a horizontal surface). When pulled at higher angles, the adhesive can tear or break off, which may prevent the adhesive from releasing any further. As a result, fragmented pieces of the adhesive may remain in the electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a plan view of an example of an electronic device, in accordance with aspects of the present disclosure.

FIG. 2 illustrates a plan view of the electronic device, showing additional features of the electronic device, in accordance with aspects of the present disclosure.

FIG. 3 illustrates a plan view of an example of an apparatus, in accordance with aspects of the present disclosure.

FIGS. 4A and 4B illustrate an example of a removal of the apparatus from a housing, in accordance with aspects of the present disclosure.

FIG. 5 illustrates a plan view of an alternate example of an apparatus, showing a layer embedded in a different pattern, in accordance with aspects of the present disclosure.

FIG. 6 illustrates a plan view of an alternate example of an apparatus, showing multiple embedded layers, in accordance with aspects of the present disclosure.

FIG. 7 illustrates a plan view of an alternate example of an apparatus, showing multiple layers networked throughout the apparatus, in accordance with aspects of the present disclosure.

FIG. 8, FIG. 9, and FIG. 10 illustrate plan views of an alternate example of an apparatus, showing a layer used to sever another layer, in accordance with aspects of the present disclosure.

FIG. 11 illustrates a side view of an alternate example of an apparatus, showing a layer embedded multiple layers of the apparatus, in accordance with aspects of the present disclosure.

FIG. 12 illustrates a side view of an alternate example of an apparatus, showing a layer embedded in a central layer of the apparatus, in accordance with aspects of the present disclosure.

FIG. 13A and FIG. 13B illustrate side views of an alternate example of an apparatus, showing a layer taking the form of memory wire, in accordance with aspects of the present disclosure.

FIG. 14 and FIG. 15 illustrate plan views of an alternate example of an apparatus, showing a layer and bubbles positioned in the apparatus, in accordance with aspects of the present disclosure.

FIG. 16 illustrates a plan view of an example of a layer having a barbed surface, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to adhesive bodies used to secure components in an electronic device, with further modifications to facilitate a subsequent removal of the adhesive body from the electronic device, thereby also removing the component. In particular, an adhesive layer may include one or more embedded layers of material for enhancing the removal operation. As an example, an apparatus may include an adhesive layer, such as a pressure sensitive adhesive (PSA) and a layer such as a wire (e.g., metal wire, non-metal wire, high tensile fibers, monofilament) within the adhesive layer. When the apparatus is pulled in tension, the adhesive layer may begin to stretch and lengthen. In some instances, the adhesive layer may tear. However, the layer (e.g., wire) may hold the adhesive layer together, regardless of tearing, such that the adhesive layer may be removed from the electronic device in its entirety. Beneficially, fragmented pieces of the adhesive layer may not be left behind in the electronic device.

Additionally, an apparatus with an adhesive layer and an embedded wire may limit or prevent damage to a component to which the apparatus is secured by the adhesive layer. For example, in one or implementations, the component takes the form of a battery for an electronic device. The battery may include delicate features, such as a thin foil. However, the adhesive layer, when pulled in tension, can still stretch and lengthen, laterally in one dimension, while reducing its size in another direction. By reducing in size, the adhesive layer may de-bond from the electronic device, thus reducing the wetting with a surface (e.g., housing) of electronic device and facilitating removal of the adhesive layer. In this regard, the Poisson ratio of the adhesive layer may facilitate removal of the apparatus, which may limiting damage to the battery. Moreover, the embedded wire may assist the adhesive layer in maintaining a favorable Poisson ratio for removal.

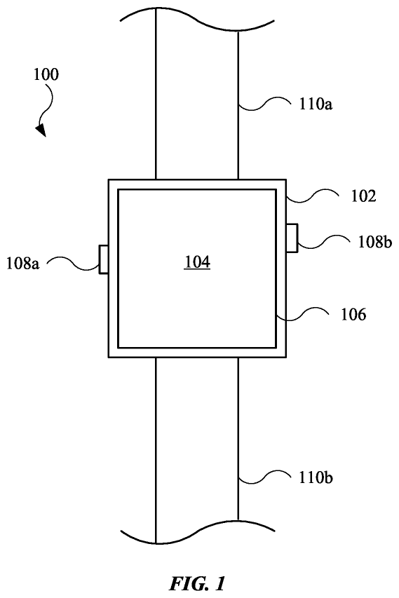

These and other embodiments are discussed below with reference to FIGS. 1-16. However, those skilled in the art will readily appreciate that the detailed description given herein with respect to these Figures is for explanatory purposes only and should not be construed as limiting.

FIG. 1 illustrates a plan view of an example of an electronic device 100, in accordance with aspects of the present disclosure. In one or more implementations, electronic device 100 takes the form of a wearable electronic device, such as a smartwatch. However, although not shown, electronic device 100 may take other forms of devices, such as a mobile wireless communication device (e.g. smartphone, tablet computing device), a desktop computing device, a laptop computing device, a display, or the like.

As shown, electronic device 100 includes a housing 102. Housing 102 may be formed from materials such as metal or plastic, as non-limiting examples. Housing 102 may define an internal volume used to carry various components of electronic device 100. Although not shown, the components may include processing circuitry (e.g., a central processing unit, a graphics processing unit), a memory circuit, a battery, and one or more cables, as non-limiting examples.

Electronic device 100 may further include a display 104 designed to present visual content in the form of textual information, still images, motion images (e.g., video), or a combination thereof. Display 104 may take the form of a capacitive touch input display, thus allowing display 104 to receive touch inputs and/or gestures from a user. Also, electronic device 100 may include a substrate 106 (e.g., glass, sapphire, plastic) that covers display 104.

Electronic device 100 may further include one or more input mechanisms that allow for user interaction to generate a command or an instruction. For example, electronic device 100 includes an input mechanism 108a and an input mechanism 108b. As non-limiting examples, input mechanisms 108a and 108b may include a button, a dial, or a combination thereof. Further, electronic device 100 may include a band 110a and a band 110b, each of which couple to housing 102. Bands 110a and 110b are designed to wrap around a body part (e.g., wrist) of a user. Bands 110a and 110b may include materials such as metal, silicone, or woven fibers, as non-limiting examples.

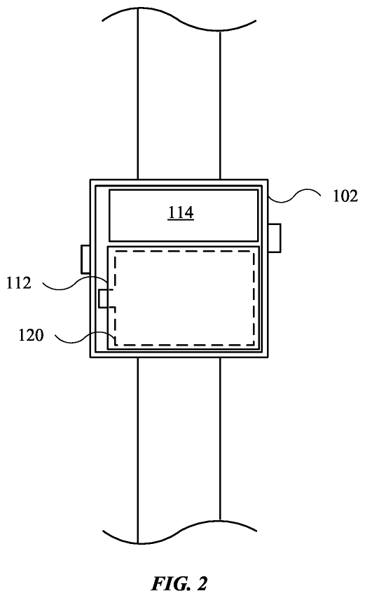

FIG. 2 illustrates a plan view of electronic device 100, showing additional features of electronic device 100, in accordance with aspects of the present disclosure. For purposes of illustration, display 104 and substrate 106 are removed. As shown, electronic device 100 includes a battery 112. Battery 112 may be used to supply power to various components, including but not limited to, display 104 (not shown in FIG. 2) and processing circuitry 114 of electronic device 100. In order to secure battery 112 with housing 102, an apparatus 120 (shown as dotted lines) may be inserted in electronic device 100 between housing 102 and battery 112. In this regard, apparatus 120 may secure (e.g., adhere) with housing 102 and battery 112.

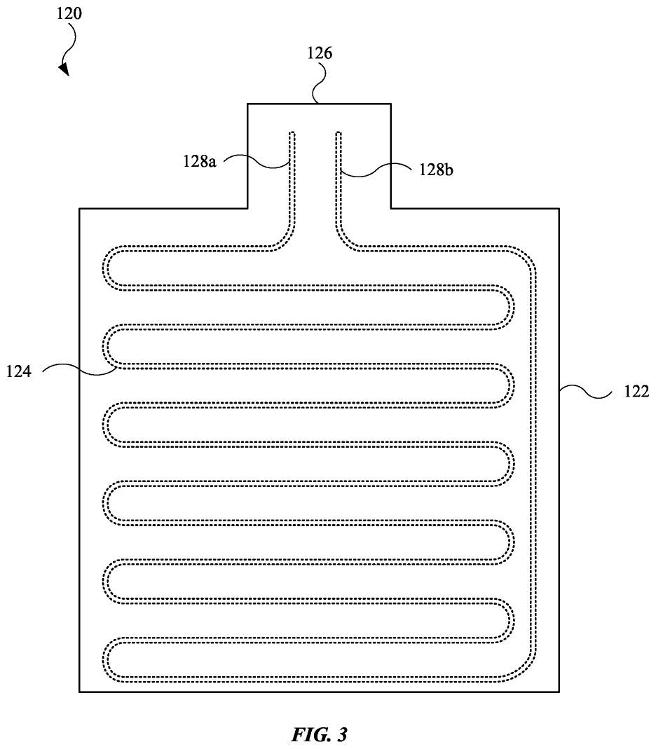

FIG. 3 illustrates a plan view of an apparatus 120, in accordance with aspects of the present disclosure. Apparatus 120 may include multiple layers. For example, apparatus 120 may include a layer 122. In one or more implementations, layer 122 includes an adhesive layer. In this regard, layer 122 may include PSA. Layer 122 may adhere (e.g., bond) with multiple structures, such as an electronic device housing and a battery. While exemplary applications described herein are directed to removal of a battery from an electronic device, an apparatus (e.g., apparatus 120) may also be used with other components, such as bonding display 104 with housing 102 (both shown in FIG. 1). Apparatus 120 may further include a layer 124 embedded within layer 122. In one or more implementations, layer 124 includes a wire (e.g., metal wire, non-metal wire, high tensile fibers, monofilament). The foregoing exemplary wire structures may generally be inelastic or non-stretchable. However, in one or more implementations, layer 124 is formed from an elastic material (e.g., nylon, rubber, elastomer). Also, layer 124 may be embedded within layer 122 in a variety of patterns or directions. For example, as shown in FIG. 3, layer 124 is embedded in layer 122 in a serpentine pattern. In this regard, layer 124 may extend, or traverse, in one direction as well as in a different (e.g., opposite) direction. Moreover, the various directions to which layer 124 extends in FIG. 3 may result in portions of layer 124 being parallel, or at least substantially parallel, with respect to each other.

Further, apparatus 120 may be designed to not only secure components with an electronic device, but also be removed from the electronic device. In this regard, apparatus 120 may further include an extension 126. Extension 126 may take the form of a tab that provides a location with which to grasp and pull apparatus 120 during removal. Layer 122 may be manipulated (e.g., cut) to form extension 126, thus making extension 126 an integrated component of layer 122.

Layer 124 may include multiple ends located in extension 126. For example, layer 124 includes an end 128a and an end 128b, representing two opposing ends of layer 124. Ends 128a and 128b may be located (e.g., embedded) in extension 126. Beneficially, when apparatus 120 is pulled in tension for removal from an electronic device by grasping extension 126, ends 128a and 128b may also be grasped, or at least indirectly grasped, causing layer 124 to move simultaneously with layer 122.

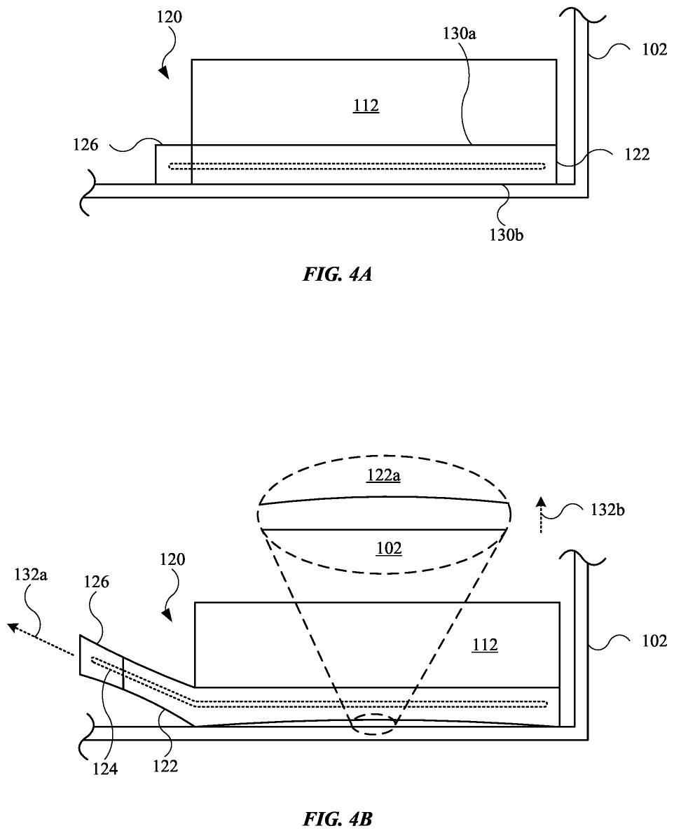

FIGS. 4A and 4B illustrate an example of a removal of apparatus 120 from housing 102, in accordance with aspects of the present disclosure. FIG. 4A illustrates a side view of apparatus 120 securing battery 112 with housing 102. When layer 122 takes the form of an adhesive layer, apparatus 120 may include multiple adhesive surfaces. For example, apparatus 120 may include an adhesive surface 130a and an adhesive surface 130b that secures apparatus 120 with battery 112 and housing 102, respectively.

FIG. 4B illustrates a side view of battery 112 being removed from housing 102 based on removing apparatus 120. As shown, a force in a direction of an arrow 132a places layer 122 in tension. As a result, a dimension of layer 122 may change. For example, layer 122 may lengthen from its prior dimension (e.g., shown in FIG. 4A). Conversely, another dimension of layer 122 may also change. For example, layer 122 may shorten, or shrink, in another dimension, causing layer 122 to move in a direction of an arrow 132b. As shown in the enlarged view, the movement (e.g., shortening/shrinking) of layer 122 causes layer 122 to decouple (e.g., de-bond) from housing 102, thus reducing the adhesive wetting from layer 122. In this regard, the Poisson ratio of layer 122 may facilitate removal of apparatus 120 from housing. Moreover, under tension, layer 122 may be susceptible to tearing, including portions of layer 122 breaking apart. However, layer 124 may maintain, or at least substantially maintain, the Poisson ratio of layer 122 until layer 122 is removed from housing 102. Also, layers 122 and 124 may bond (e.g., adhesively bond) together such that layers 122 and 124 may move together. In this regard, layer 124 may remain coupled to, or engaged with, any fragments or portions of layers 122 that become torn and separated from other portions of layer 122.

By relying on apparatus 120 to secure battery 112 in housing 102, an electronic device may forego other structures (e.g., brackets, fasteners) to retain battery 112. Beneficially, additional spaces for the structures is no longer needed, and other structures and/or a larger battery may be used. Also, by embedding layer 124 into layer 122, apparatus 120 can be pulled in tension at relatively higher angles (e.g., between extension 126 and housing 102) with less risk of layer 122 be torn and remaining within housing 102.

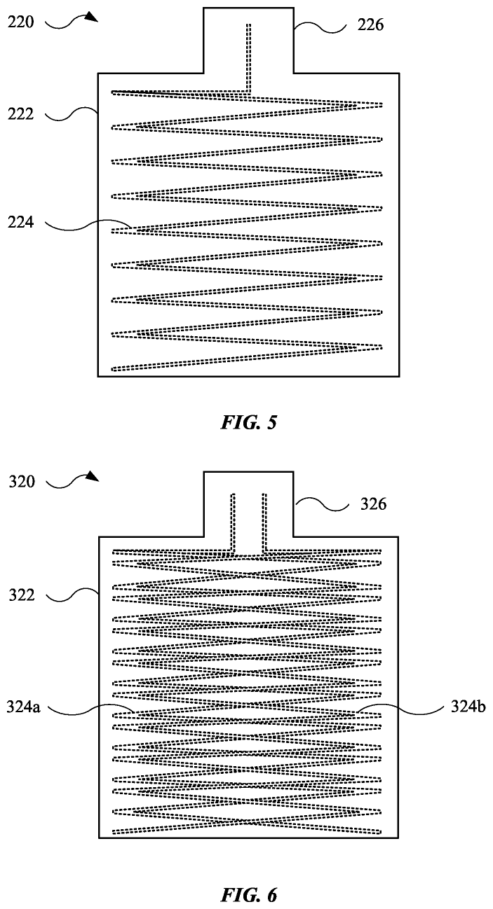

FIGS. 5-15 show and describe different examples of an apparatus. The examples for an apparatus shown and/or described in FIGS. 5-15 may include at least some features shown and/or described herein for apparatus 120 (shown in FIGS. 3-4B). Further, apparatus 120 may be modified to include at least some features shown and/or described herein for an apparatus in FIGS. 5-15.

FIG. 5 illustrates a plan view of an alternate example of an apparatus 220, showing a layer embedded in a different pattern, in accordance with aspects of the present disclosure. As shown, apparatus 220 may include a layer 222 (e.g., adhesive layer) and a layer 224 (e.g., wire) embedded in layer 222. Apparatus 220 may further include an extension 226 formed from layer 222. Layer 224 may be positioned with multiple portions that are non-parallel (e.g., diagonal) with respect to each other. Put another way, layer 224 may be positioned in accordance with a zig-zag pattern.

FIG. 6 illustrates a plan view of an alternate example of an apparatus 320, showing multiple embedded layers, in accordance with aspects of the present disclosure. As shown, apparatus 320 may include a layer 322 (e.g., adhesive layer). Further, apparatus may include a layer 324a and a layer 324b (e.g., wires) embedded in layer 322. Apparatus 320 may further include an extension 326 formed from layer 322. Layers 324a and 324b may be positioned with multiple portions that are non-parallel (e.g., diagonal) with respect to each other. Put another way, layers 324a and 324b may be positioned in accordance with a zig-zag pattern. By using multiple layers (e.g., layers 324a and 324b), apparatus 320 may include additional bonding points between layer 322 and layers 324a and 324b, thus increasing the likelihood of apparatus 320 being removed in its entirety.

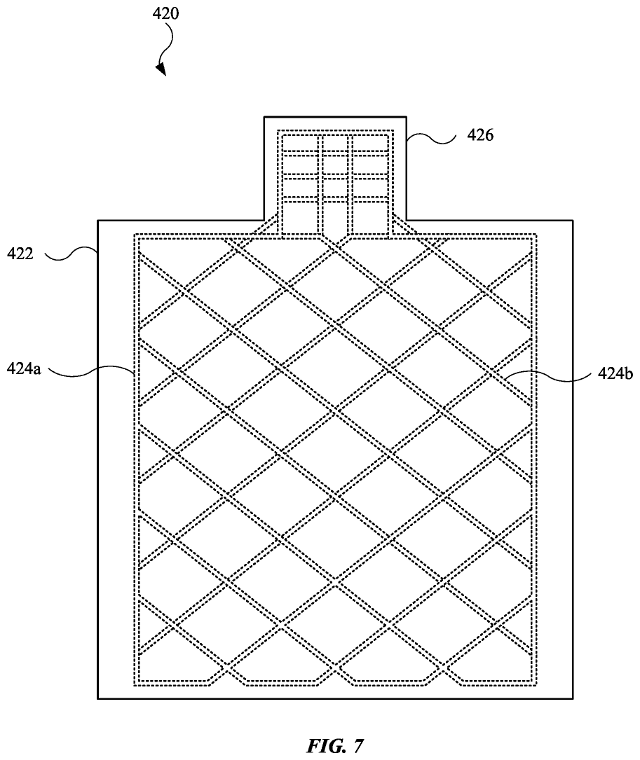

FIG. 7 illustrates a plan view of an alternate example of an apparatus 420, showing multiple layers networked throughout apparatus 420, in accordance with aspects of the present disclosure. As shown, apparatus 420 may include a layer 422 (e.g., adhesive layer). Further, apparatus may include a layer 424a and a layer 424b (e.g., wires) embedded in layer 422. Apparatus 420 may further include an extension 426 formed from layer 422. Layers 424a and 424b (representative of one or more additional layers) provide regions of several parallel and non-parallel portions of layers. As shown in FIG. 7, at least some portions of layers 424a and 424b are perpendicular with respect to other portions of layers 424a and 424b. Moreover, layers 424a and 424b extend throughout layer 422 in different directions. In this regard, apparatus 420 may include additional bonding points between layer 422 and layers 424a and 424b, including in extension 426.

When layers of an apparatus include metal, an apparatus may provide electromagnetic (EM) shield in addition to bonding capabilities. For example, when layers 424a and 424b include metal wires, apparatus 420 may provide a Faraday cage. In this regard, apparatus 420 may provide an EM shield that either prevents of exposure of a component (e.g., wireless communication circuit) in an electronic device to EM radiation, or blocks EM radiation from the component. Beneficially, an additional EM shielding layer(s) may not be required in an electronic device based on the additional features of apparatus 420.

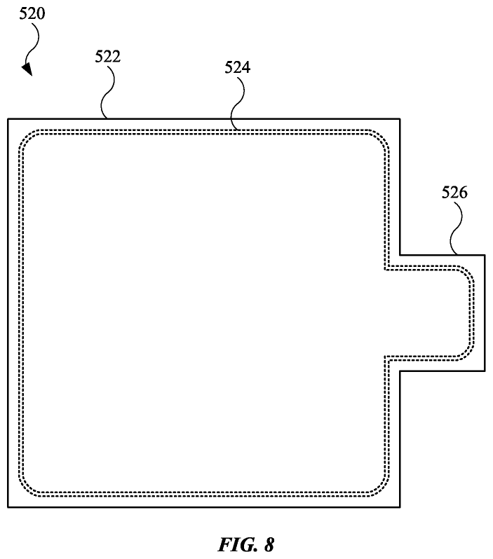

FIG. 8, FIG. 9, and FIG. 10 illustrate a plan view of an alternate example of an apparatus, showing a layer used to separate another layer, in accordance with aspects of the present disclosure. FIG. 8 illustrates an plan view of an apparatus 520. Apparatus 520 includes a layer 522 (e.g., adhesive layer) and a layer 524 (e.g., wire) embedded in layer 522. Apparatus 520 further includes an extension 526 formed from layer 522. As shown, layer 524 extends along, or near, a perimeter of layer 522 as well as extension 526.

FIG. 9 illustrates a side view of apparatus 520. In response to a pulling force to extension 526 that causes tension in apparatus 520, layer 524 may cause a separation of layer 522. FIG. 10 illustrates a side view of apparatus 520, showing layer 524 separating layer 522. As shown, a force applied to extension 526 in the direction of an arrow 532 causes extension 526 to separate from layer 522. Further, layer 524 may move with extension 526, thereby cutting, severing, or otherwise separating layer 522 into a section 534a and a 534b. When layer 522 takes the form of an adhesive layer, each of sections 534a and 534b may be referred to as an adhesive portion. When a component (e.g., battery) of an electronic device (not shown in FIG. 10) is adhesively secured with apparatus 520, the component may be removed with section 534a, while section 534b may remain in the electronic device. However, section 534b may be readily cleaned and removed from the electronic device.

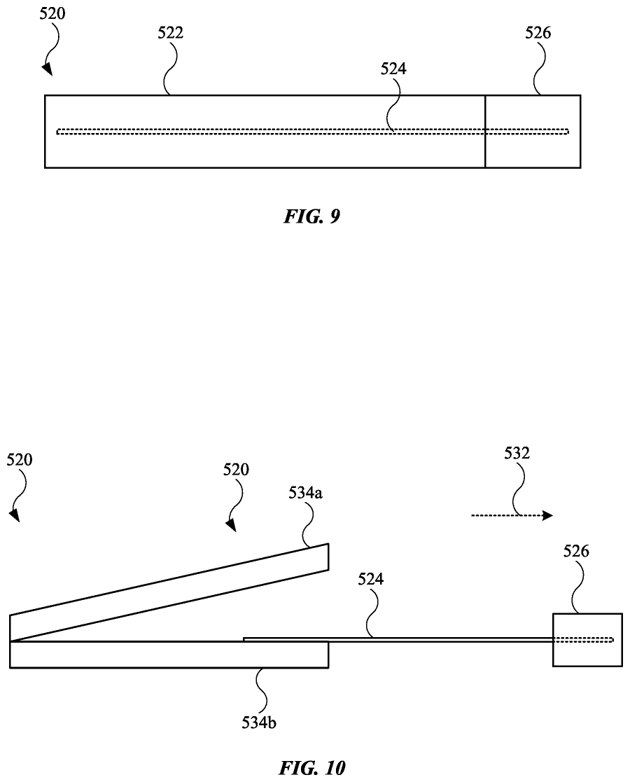

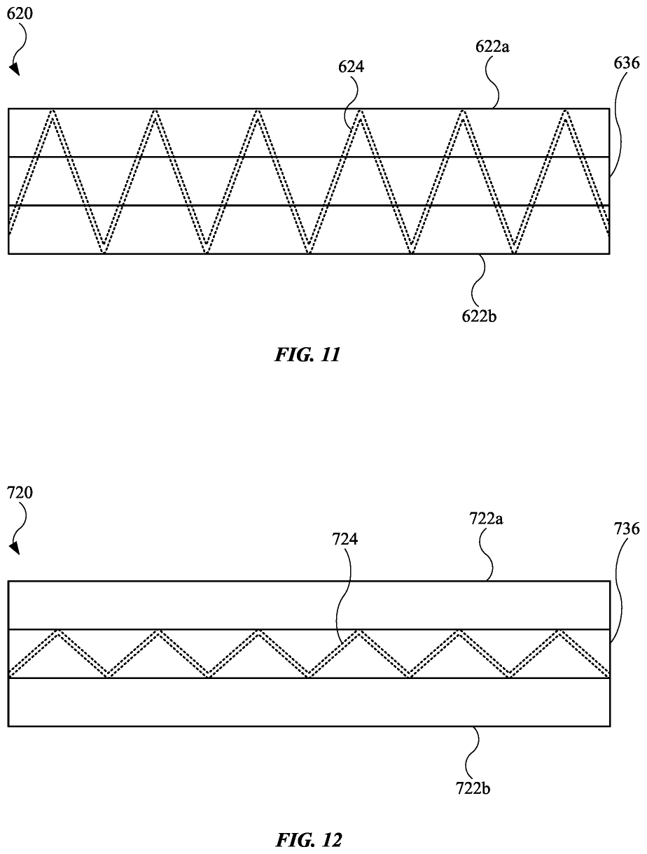

FIG. 11 illustrates a side view of an alternate example of an apparatus 620, showing a layer extending through multiple layers of apparatus 620, in accordance with aspects of the present disclosure. As shown, apparatus 620 includes a layer 622a and a layer 622b. In one or more implementations, each of layers 622a and 622b take the form of an adhesive, and each of layers 622a and 622b may be referred to as an adhesive portion. Additionally, apparatus 620 may include a layer 636 positioned (e.g., centrally located) between layers 622a and 622b. In one or more implementations, layer 636 takes the form of a carrier layer that carries layer 624. As non-limiting examples, layer 636 may be formed from polyethylene terephthalate (PET) or polyurethane. Also, apparatus 620 may further includes a layer 624 embedded in layers 622a and 622b, as well as in layer 636. In one or more implementations, layer 624 is weaved and/or stitched with layer 636.

In some instances, when a force (e.g., tension) is applied to an apparatus, a layer (e.g., wire) may slip through, or move relative to, another layer (e.g., adhesive), leaving the other layer behind in an electronic device. However, when integrating layer 636 into apparatus 620 and further passing layer 624 through layers 622a, 622b, and 636, layer 624 is limited or prevented from slipping through layers 622a, 622b, and 636. As a result, when the force is applied to layer 624, layers 622a, 622b, and 636 move with layer 624, causing apparatus 620 to be removed in a desired manner.

Further, in one or more implementations, layer 624 may be used to provide an electrical connection between two components. For example, when layer 624 includes an electrically conductive material (e.g., copper), and further extends to an outermost surface (e.g., upper surface) of layer 622a as well as to an outermost surface (e.g., lower surface) of layer 622b, layer 624 may electrically couple together components connected to the respective outermost surfaces of layers 622a and 622b.

FIG. 12 illustrates a side view of an alternate example of an apparatus 720, showing a layer embedded in a central layer of the apparatus, in accordance with aspects of the present disclosure. Similar to the prior example, apparatus 720 includes a layer 722a and a layer 722b (e.g., adhesive layers), and a layer 736 (e.g., PET layer) that takes the form of a carrier layer between layers 722a and 722b. Further, apparatus 720 may include a layer 724 embedded in layer 736 but not in layers 722a and 722b. Based on the design configuration, layers 724 and 736 may be part of a sub-assembly of apparatus 720 that may be readily integrated with layers 722a and 722b. When tension is applied to apparatus 720, layer 724 may be pulled in tension, which may also cause layer 736 to be pulled in tension. As a result, layers 722a and 722b may be removed from an electronic device (not shown in FIG. 12) without delaminating or de-bonding from layer 736. Alternatively, layers 724 and 736 may separate one of layers 722a or 722b from apparatus 720.

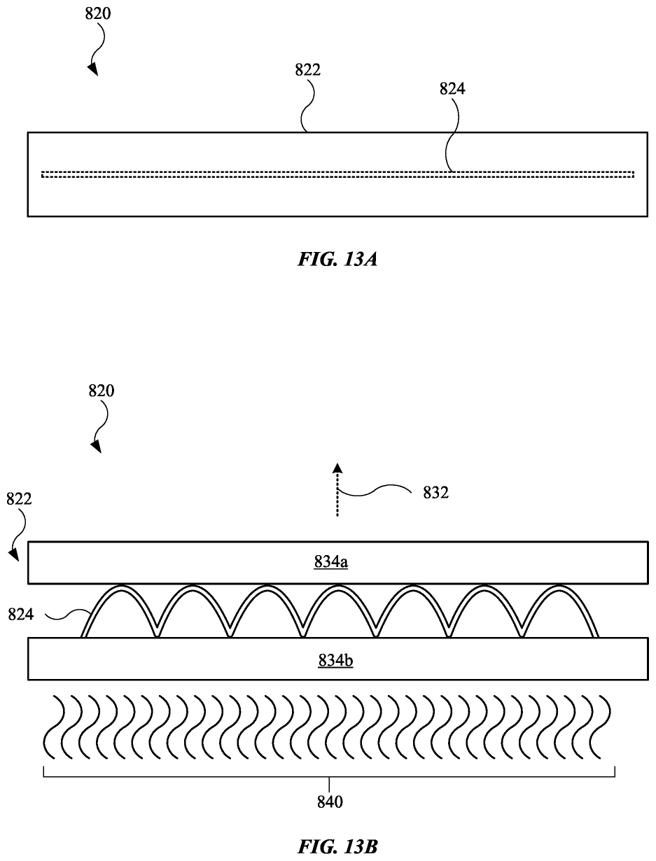

FIG. 13A and FIG. 13B illustrate side views of an alternate example of an apparatus 820, showing a layer 824 taking the form of memory wire, in accordance with aspects of the present disclosure. FIG. 13A illustrates apparatus 820 having a layer 822 (e.g., adhesive) and a layer 824 (e.g., wire) embedded in layer 822. Although not expressly shown, apparatus 820 may further include an extension (e.g., tab). In one or more implementations, layer 824 includes nickel titanium (e.g., nitinol). In this regard, layer 824 may be set to an initially desired shape, and subsequently bent or formed to another shape. The subsequent shape may be generally flat in one dimension, as shown in FIG. 13A.

FIG. 13B illustrates thermal energy 840 (e.g., heat) being applied to apparatus 820. When layer 824 is exposed to a threshold amount thermal energy, layer 824 changes and returns to its original shape. Based on the shape of layer 824 shown in FIG. 13B, layer 824 may separate layer 822 into a section 834a and a section 834b. As shown, section 834a is moved (relative to section 834b) in a direction of an arrow 832 based on layer 824 changing shape. When layer 822 takes the form of an adhesive layer, each of sections 834a and 834b may be referred to as an adhesive portion. When a component (e.g., battery) of an electronic device (not shown in FIG. 13B) is adhesively secured with apparatus 820, the component may be removed with section 834a, while section 834b may remain in the electronic device. However, section 834b may be readily cleaned and removed from the electronic device. While FIG. 13B shows thermal energy externally applied to layer 824, in one or more implementations, layer 824 may include an electrically conductive layer (e.g., metal wire). In this regard, an electrical current may pass through layer 824, resulting in electrical resistance from layer 824, which generates at least the threshold amount thermal energy to cause layer 824 to return to its original shape, as shown in FIG. 13B.

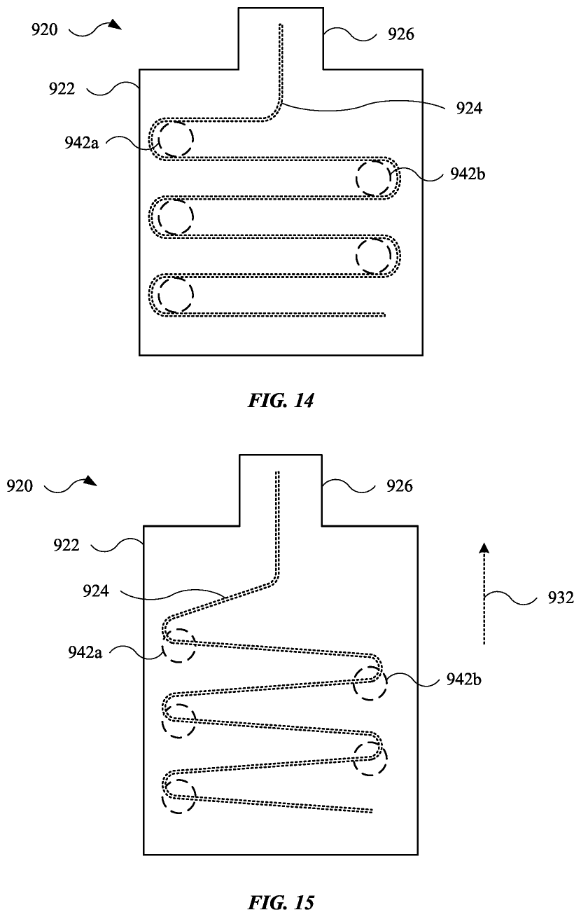

FIG. 14 and FIG. 15 illustrate plan views of an alternate example of an apparatus 920, showing a layer and a solvent positioned in apparatus 920, in accordance with aspects of the present disclosure. FIG. 14 illustrates shows apparatus 920 including a layer 922 (e.g., adhesive layer) and a layer 924 (e.g., wire) embedded in layer 922. Apparatus 920 may further include an extension 926 formed from layer 922. Apparatus 920 may further include several bubbles, or pockets, holding a solution. For example, apparatus 920 may include a bubble 942a and a bubble 942b (representative of additional bubbles) embedded in layer 922. In one or more implementation, the solution in the bubbles 942a and 924b includes a solvent, thus forming solvent bubbles. Further, layer 924 may extend around each of the bubbles in a serpentine pattern, as a non-limiting example.

FIG. 15 illustrates apparatus 920 under tension in a direction of an arrow 932. When apparatus 920 is removed from an electronic device (not shown in FIG. 15), a pulling force may be applied to extension 926. As a result, layer 924 may move. Based on (relative) movement, layer 924 may cut, sever, or otherwise break the bubbles. For example, layer 924 cuts through bubbles 942a and 942b as shown in FIG. 15. When bubbles 942a and 942b are cut by layer 924, the solution may be released. When the solution includes a solvent, the solvent may cause layer 922 to de-bond from an electronic device, thus facilitating removal of apparatus 920 from the electronic device.

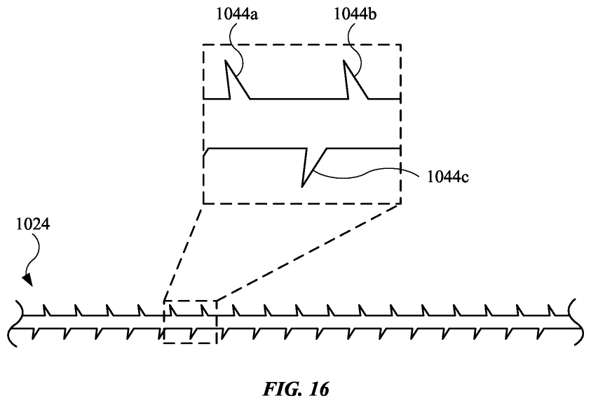

FIG. 16 illustrates a plan view of an example of a layer 1024 having a barbed surface, in accordance with aspects of the present disclosure. As shown in the enlarged view, layer 1024 may include a barb 1044a, a barb 1044b, and a barb 1044c, each being representative of several additional barbs on layer 1024. Barbs 1044a, 1044b and 1044c may serve several functions. For example, barbs 1044a, 1044b and 1044c may provide additional adhesion surfaces to further bond with an adhesive layer (not shown in FIG. 16) in which layer 1024 is positioned. Additionally, barbs 1044a, 1044b and 1044c may provide additional mechanical interlocking with an adhesive layer in which layer 1024 is positioned. In this regard, when an apparatus (not shown in FIG. 16) is being removed from an electronic device, barbs 1044a, 1044b and 1044c may enhance the coupling or bonding with an adhesive layer, thus increasing the likelihood of the apparatus being fully removed from the electronic device. It should be noted that layer 1024 may substitute for other layers (e.g., layer 124 shown in FIG. 3 as a non-limiting example).

Various examples of aspects of the disclosure are described below as clauses for convenience. These are provided as examples, and do not limit the subject technology.

Clause A: An apparatus may include a first layer configured to secure to a structure. The first layer including an extension. The apparatus may further include a second layer embedded in the first layer. The second layer may extend in a first direction and a second direction different from the first direction. In one or more implementations, in response to a force applied the extension, the first layer lengthens to decouple from the structure and the second layer moves with the second layer.

Clause B: An apparatus may include an adhesive layer configured to secure to a structure. The adhesive layer may include a first adhesive portion, a second adhesive portion, and a carrier layer positioned between the first adhesive portion and the second adhesive portion. The apparatus may further include a wire positioned in the carrier layer.

Clause C: An electronic device may include a housing that defines an internal volume. The electronic device may further include a battery positioned in the internal volume. The electronic device may further include an apparatus configured to secure the battery to the housing. The apparatus may include a first layer configured to secure to a structure. The first layer may include an extension. The apparatus may further include a second layer embedded first layer. The second layer may extend in a first direction and a second direction different from the first direction. In one or more implementations, in response to a force applied the extension, the first layer lengthens to detach from the structure and the second layer moves with the first layer.

One or more of the above clauses can include one or more of the features described below. It is noted that any of the following clauses may be combined in any combination with each other, and placed into a respective independent clause, e.g., clause A, B, or C.

Clause 1: wherein the first layer includes an adhesive layer. The adhesive layer may include a first adhesive surface configured to adhere to the structure, and a second adhesive surface opposite the first adhesive surface. The second adhesive surface may be configured to secure the adhesive layer with an electronic device.

Clause 2: wherein: the second layer includes a wire that includes a first end and a second end opposite the first end, and the first end extends into the extension.

Clause 3: wherein the second end extends into the extension.

Clause 4: wherein the second direction is perpendicular with respect the first direction.

Clause 5: wherein the second layer further extends in a third direction that is parallel with respect the first direction.

Clause 6: wherein the second layer includes a metal wire.

Clause 7: wherein: the second layer includes a first shape, and in response to thermal energy, the second layer changes from the first shape to a second shape, and separates, based on the second shape, the first layer into a first section portion and a second section.

Clause 8: further including a plurality of solvent bubbles, wherein in response to the force, the second layer is configured to cut at least some of the plurality of solvent bubbles.

Clause 9: wherein in response to the force, the second layer is configured to separate the first layer into a first adhesive portion and a second adhesive portion.

Clause 10: further including an extension, wherein in response to a force applied the extension, the adhesive layer lengthens to decouple from the structure and the wire moves with the adhesive layer.

Clause 11: wherein the wire extends into the extension.

Clause 12: wherein the wire is positioned in the first adhesive portion and the second adhesive portion.

Clause 13: wherein the wire is selected from a metal wire or a non-metal wire.

Clause 14: wherein the wire includes a barbed surface.

Clause 15: wherein the wire extends in a first direction and a second direction that is non-parallel with respect to the first direction.

Clause 16: wherein: the first layer includes an adhesive layer, the second layer includes a first wire that includes a first end and a second end opposite the first end, and the first end and the second end extend into the extension.

Clause 17: further including a third layer. The third layer may include a second wire.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a first layer configured to secure to a structure, the first layer comprising an extension; and
a second layer embedded in the first layer, the second layer extending in a first direction and a second direction different from the first direction, wherein in response to a force applied the extension, the first layer lengthens to decouple from the structure and the second layer moves with the second layer.

2. The apparatus of claim 1, wherein the first layer comprises:
an adhesive layer comprising:
a first adhesive surface configured to adhere to the structure, and
a second adhesive surface opposite the first adhesive surface, the second adhesive surface configured to secure the adhesive layer with an electronic device.

3. The apparatus of claim 1, wherein:
the second layer comprises a wire that includes a first end and a second end opposite the first end, and
the first end extends into the extension.

4. The apparatus of claim 3, wherein the second end extends into the extension.

5. The apparatus of claim 1, wherein the second direction is perpendicular with respect the first direction.

6. The apparatus of claim 1, wherein the second layer further extends in a third direction that is parallel with respect the first direction.

7. The apparatus of claim 1, wherein the second layer comprises a metal wire.

8. The apparatus of claim 1, wherein:
the second layer comprises a first shape, and
in response to thermal energy, the second layer changes from the first shape to a second shape, and separates, based on the second shape, the first layer into a first section portion and a second section.

9. The apparatus of claim 1, further comprising a plurality of solvent bubbles, wherein in response to the force, the second layer is configured to cut at least some of the plurality of solvent bubbles.

10. The apparatus of claim 1, wherein in response to the force, the second layer is configured to separate the first layer into a first adhesive portion and a second adhesive portion.

11. An apparatus, comprising:
an adhesive layer configured to secure to a structure, the adhesive layer comprising:
a first adhesive portion,
a second adhesive portion, and
a carrier layer positioned between the first adhesive portion and the second adhesive portion; and
a wire positioned in the carrier layer.

12. The apparatus of claim 11, further comprising an extension, wherein in response to a force applied the extension, the adhesive layer lengthens to decouple from the structure and the wire moves with the adhesive layer.

13. The apparatus of claim 12, wherein the wire extends into the extension.

14. The apparatus of claim 11, wherein the wire is positioned in the first adhesive portion and the second adhesive portion.

15. The apparatus of claim 11, wherein the wire is selected from a metal wire or a non-metal wire.

16. The apparatus of claim 11, wherein the wire comprises a barbed surface.

17. The apparatus of claim 11, wherein the wire extends in a first direction and a second direction that is non-parallel with respect to the first direction.

18. An electronic device, comprising:
a housing that defines an internal volume;
a battery positioned in the internal volume; and
an apparatus configured to secure the battery to the housing, the apparatus comprising:
a first layer configured to secure to a structure, the first layer comprising an extension; and
a second layer embedded in the first layer, the second layer extending in a first direction and a second direction different from the first direction, wherein in response to a force applied the extension, the first layer lengthens to detach from the structure and the second layer moves with the first layer.

19. The electronic device of claim 18, wherein:
the first layer comprises an adhesive layer,
the second layer comprises a first wire that includes a first end and a second end opposite the first end, and
the first end and the second end extend into the extension.

20. The electronic device of claim 19, further comprising a third layer, wherein the third layer comprises a second wire.
